(19) United States
(12) Patent Application Publication
(10) Pub. No.: US 2024/0284979 A1
(43) Pub. Date: Aug. 29, 2024

(54) FLAVOR INHALER AND FLAVOR INHALATION SYSTEM

(71) Applicant: Japan Tobacco Inc., Tokyo (JP)

(72) Inventors: Yasunobu INOUE, Tokyo (JP); Ryoji FUJITA, Tokyo (JP); Kazutoshi SERITA, Tokyo (JP); Sumie MIKAMI, Tokyo (JP)

(73) Assignee: Japan Tobacco Inc., Tokyo (JP)

(21) Appl. No.: 18/655,377

(22) Filed: May 6, 2024

Related U.S. Application Data
(63) Continuation of application No. PCT/JP2021/045067, filed on Dec. 8, 2021.

(51) Int. Cl. A24F 40/46; A24F 40/20; A24F 40/57; H05B 3/46

(52) U.S. Cl. CPC A24F 40/46; A24F 40/20; A24F 40/57; H05B 3/46

(57) ABSTRACT

A flavor inhaler comprises a heater, wherein the heater comprises: a heating element which includes a plurality of heating portions; and a plurality of first energization regions electrically connected to the respective heating portions.

### CROSS-REFERENCE TO RELATED APPLICATION

The present invention is a bypass continuation of PCT Application No. PCT/JP2021/045067 filed on Dec. 8, 2021, the entire contents of which are incorporated herein by reference.

### TECHNICAL FIELD

The present invention relates to a flavor inhaler and a flavor inhalation system.

### BACKGROUND ART

Known arts provide flavor inhalers for inhaling flavors or the like without burning materials. Various heaters have been proposed for use in such flavor inhalers (see PTL 1). One of such heaters is known to include a plurality of heating regions for heating a plurality of portions of a smoking material (see PTL 2).

### CITATION LIST

### Patent Literature

PTL 1: Chinese Utility Model No. 209807157

PTL 2: Japanese Unexamined Patent Application Publication (Translation of PCT Application) No. 2019-518430

### SUMMARY OF INVENTION

### Technical Problem

In a flavor inhaler such as the one disclosed in PTL 2, if, for example, electrically conductive heat-generating portions are distributed in a complicated pattern, heating control for individual ones of the plurality of portions of the smoking material or the like may be unsatisfactory. An object of the present invention is to provide a flavor inhaler and a flavor inhalation system each including a heater in which a plurality of heating portions are individually controllable with increased accuracy.

### Solution to Problem

According to a first aspect, there is provided a flavor inhaler. The flavor inhaler comprises a heater. The heater comprises a heating element which includes a plurality of heating portions; and a plurality of first energization regions electrically connected to the respective heating portions.

According to the first aspect, individual ones of the plurality of heating portions are controllable flexibly through the first energization regions. Therefore, the flavor component is releasable in correspondence with the preference, convenience, or the like of the user of the flavor inhaler (hereinafter simply referred to as the user).

According to a second aspect, the flavor inhaler according to the first aspect further comprises a heating controller configured to control heating by electrically controlling individual ones of the plurality of first energization regions.

According to the second aspect, individual ones of the plurality of heating portions are controllable more flexibly through the first energization regions.

According to a third aspect, in the second aspect, the heating controller is configured to control the plurality of first energization regions in such a manner as to heat in order of a first heating region and a second heating region, the first heating region and the second heating region each including one or more of the plurality of heating portions. Furthermore, a surface area of the second heating region is greater than a surface area of the first heating region.

According to the third aspect, since the first heating region is heated with priority, the temperature of a flavor-generating base to be heated by the first heating region rises quickly. Therefore, the time from when the flavor inhaler is activated until the user is able to inhale the flavor is shortened.

According to a fourth aspect, in the third aspect, the first heating region is located, along a path of an airflow generated by flavor inhalation, on a downstream side relative to the second heating region.

According to the fourth aspect, a portion of the flavor-generating base to be heated by the first heating region is not hindered by another portion from being inhaled by the user. Therefore, for example, the amount of the flavor component to be initially inhaled by the user after the activation of the flavor inhaler is increased.

According to a fifth aspect, in any of the first to fourth aspects, the heater further comprises one or a plurality of second energization regions. Furthermore, the plurality of first energization regions or the one or the plurality of second energization regions each include electrically conductive adhesive or a metal electrode.

According to the fifth aspect, individual ones of the plurality of heating portions are controllable flexibly and more assuredly by utilizing the characteristic of the electrically conductive adhesive or the metal electrode.

According to a sixth aspect, in the fifth aspect, the metal electrode includes stainless steel.

According to the sixth aspect, the heating element is supported by utilizing the rigidity of stainless steel.

According to a seventh aspect, in the fifth or six aspect, the heater comprises the second energization region that faces both a region between the plurality of first energization regions and the plurality of first energization regions.

According to the seventh aspect, the processing work of obtaining the second energization region is facilitated. Furthermore, if the second energization region is formed of a metal electrode, the heating element is supported by the second energization region.

According to an eighth aspect, in the fifth or sixth aspect, the plurality of second energization regions each have a shape based on a corresponding one of the first energization regions that overlap respective ones of the plurality of second energization regions.

According to the eighth aspect, individual ones of the plurality of heating portions are controllable much more flexibly through the first energization regions and the second energization regions.

According to a ninth aspect, in any of the fifth to eighth aspects, the heater comprises a connecting electrode electrically connected to the first energization region or to the one or the plurality of second energization regions and extending in a long-side direction of the heating element.

According to the ninth aspect, a flavor inhaler extending in the long-side direction that is suitable for flavor inhalation is easily obtained.

According to a tenth aspect, in the ninth aspect, the connecting electrode includes a connecting part provided for external connection and being located at or near an end face of the connecting electrode, with a surface of the connecting electrode excluding the connecting part being insulated.

According to the tenth aspect, the occurrence of short circuit between the connecting electrodes and between the connecting electrode and another electrode is suppressed. Furthermore, the formation of the connecting parts is facilitated.

According to an eleventh aspect, in the ninth or tenth aspect, any electrodes excluding the connecting electrode extend along a surface at which the heating element extends, without protruding from an area in which the heating element extends.

According to the eleventh aspect, the occurrence of short circuit in a direction perpendicular to the surface at which the heating element extends is suppressed.

According to a twelfth aspect, in any of the fifth to eleventh aspects, the plurality of first energization regions or the one or the plurality of second energization regions are covered with glass.

According to the twelfth aspect, the occurrence of short circuit between each of the first energization regions and the second energization regions and another conductive element is suppressed.

According to a thirteenth aspect, in any of the first to twelfth aspects, the flavor inhaler further comprises an accommodation part configured to accommodate a consumable material having a flavor component. Furthermore, the consumable material is to be positioned in the accommodation part such that the heater is inserted into the consumable material.

According to the thirteenth aspect, the consumable material is heated efficiently by the heater. Furthermore, the consumable material is easily secured.

According to a fourteenth aspect, in any of the first to thirteenth aspects, the heating element includes a PTC element.

According to the fourteenth aspect, the characteristic of the PTC element makes the current difficult to flow through after a predetermined temperature is reached. Therefore, a safe flavor inhaler is provided with no complicated control operation.

According to a fifteenth aspect, in any of the first to fourteenth aspects, the heating element has a flat plate shape.

According to the fifteenth aspect, the arrangement of the first energization regions in correspondence with the respective heating portions is facilitated. Therefore, individual ones of the plurality of heating portions are controllable flexibly and more assuredly.

According to a sixteenth aspect, in the fifteenth aspect, the first energization regions each have a flat plate shape. Furthermore, the heating element and the first energization regions overlap each other in a thicknesswise direction of the heating element. Furthermore, the heating element allows a current to flow through in the thicknesswise direction.

According to the sixteenth aspect, the current flows evenly over the areas where the flat plate-like heating element and the first energization regions overlap each other. Therefore, the consumable material is heated more evenly than with a heater in which heat is generated by metal wiring.

According to a seventeenth aspect, in any of the first to sixteenth aspects, the heating element of the heater is a lamination of two or more heating elements.

According to the seventeenth aspect, the electrodes are shared between the heating elements. Therefore, the flavor inhaler is manufacturable efficiently. Furthermore, the two or more heating elements are controllable independently of each other. Therefore, more flexible heating control is possible.

According to an eighteenth aspect, there is provided a flavor inhalation system. The flavor inhalation system comprises a consumable material having a flavor component; and the flavor inhaler according to any of the first to seventeenth aspects.

According to the eighteenth aspect, individual ones of the plurality of heating portions are controllable flexibly through the first energization regions. Therefore, the flavor component is releasable in correspondence with the user's preference, convenience, or the like.

According to a nineteenth aspect, in the eighteenth aspect, the consumable material includes a plurality of portions each being positioned facing a corresponding one of the plurality of heating portions at a time of inhalation, the plurality of portions having respective flavor components.

According to the nineteenth aspect, the release of the flavor components is controllable more flexibly. Furthermore, flavor components are providable in the plurality of portions in correspondence with the user's preference, convenience, or the like.

### BRIEF DESCRIPTION OF DRAWINGS

FIG. 1 is a sectional view of a relevant part of a flavor inhaler according to an embodiment, taken in the widthwise direction of a heater.

FIG. 2 is a sectional view of the relevant part of the flavor inhaler according to the embodiment, taken in the thicknesswise direction of the heater.

FIG. 3 is a conceptual diagram illustrating the heater and a controller according to the embodiment.

FIG. 4A is a conceptual diagram illustrating a first surface of the heater according to the embodiment.

FIG. 4B is a conceptual diagram illustrating a second surface of the heater according to the embodiment.

FIG. 5A is a conceptual diagram illustrating an A1-A1 section taken from FIG. 4A.

FIG. 5B is a conceptual diagram illustrating an A2-A2 section taken from FIG. 4A.

FIG. 5C is a conceptual diagram illustrating an A3-A3 section taken from FIG. 4A.

FIG. 6A is a schematic side sectional view of a consumable material according to the embodiment.

FIG. 6B is a conceptual diagram illustrating a section of a tobacco part that is taken orthogonally to the long-side direction of the consumable material illustrated in FIG. 6A.

FIG. 7 illustrates in sectional view how the consumable material is accommodated into the flavor inhaler.

FIG. 8 illustrates in sectional view how the consumable material is accommodated into the flavor inhaler.

FIG. 9 illustrates in sectional view how the consumable material is accommodated into the flavor inhaler.

FIG. 10 is a flow chart illustrating a process of releasing flavor according to the embodiment.

FIG. 11 is a conceptual diagram illustrating a second surface of a heater according to Modification 1.

FIG. 12 is a schematic side sectional view of a consumable material according to Modification 2.

FIG. 13 is a schematic perspective view of a heater according to Modification 3.

### DESCRIPTION OF EMBODIMENTS

An embodiment of the present invention will now be described with reference to the drawings. In the drawings to be referred to below, like or equivalent elements are denoted by like reference signs, and redundant description thereof is omitted. While the following embodiment takes a tobacco stick as an exemplary consumable material, the consumable material is not limited to tobacco, as long as the material generates flavor when heated.

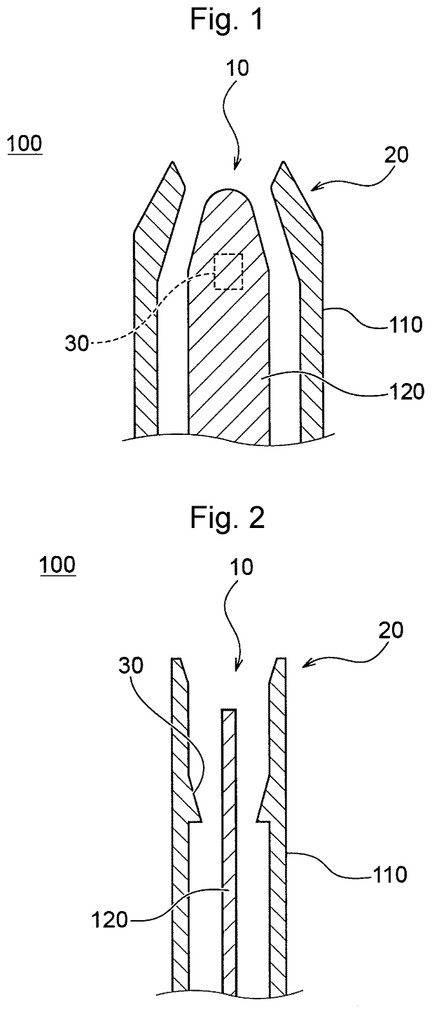

FIG. 1 is a sectional view of a relevant part of a flavor inhaler 100 according to an embodiment of the present invention, taken in the widthwise direction of a heater 120. FIG. 2 is a sectional view of the relevant part of the flavor inhaler 100, taken in the thicknesswise direction of the heater 120.

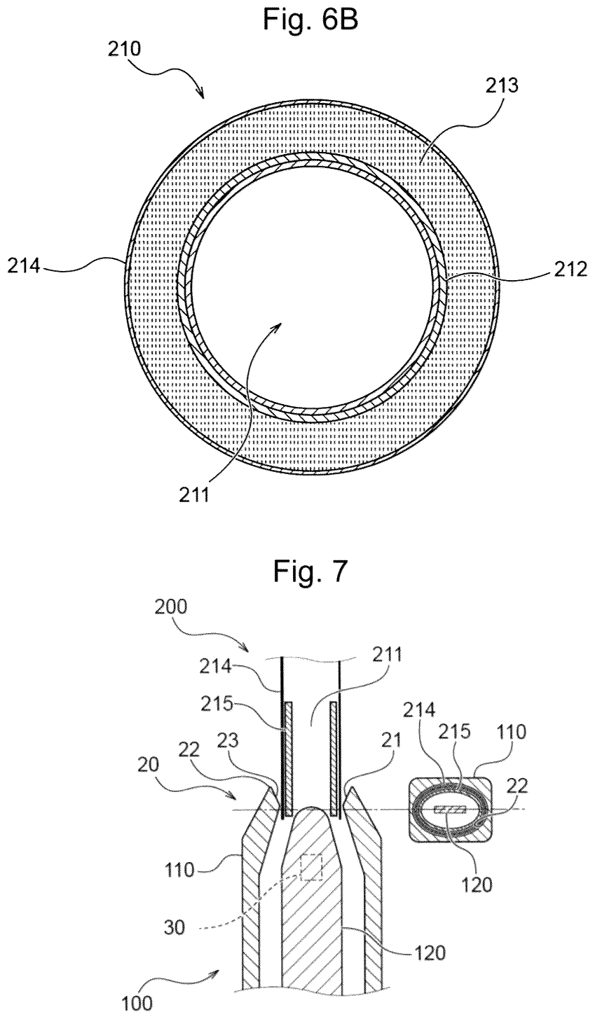

As illustrated in FIGS. 1 and 2, the flavor inhaler 100 includes a housing 110 and the heater 120. The housing 110 has an opening 10 at one end thereof and serves as an accommodation part that is to accommodate at least a portion of a consumable material 200 (FIG. 6A), which is to be inserted into the opening 10 through the opening 10. The housing 110 is made of resin, for example. In particular, the housing 110 may be made of PC (polycarbonate), ABS (acrylonitrile-butadiene-styrene) resin, PEEK (polyether ether ketone), a polymer alloy containing a plurality of polymers, or the like. Alternatively, the housing 110 may be made of metal such as aluminum. The housing 110 is designed such that the area of the section that is taken orthogonally to the long-side direction thereof is smallest near the opening 10.

The housing 110 includes a shaping guide (guide part) 20 and retaining ribs (urging parts) 30. The shaping guide 20 defines the opening 10 and is designed to deform, in conformity with the shape of the heater 120, the cross-sectional shape of the consumable material 200 that is inserted into the housing 110. The retaining ribs 30 are provided on the inner peripheral surface of the housing 110 and are designed to urge against the heater 120 the consumable material 200 that is inserted into the housing 110, thereby deforming the consumable material 200.

The housing 110 further has an air intake, which is not illustrated but is located opposite the opening 10; that is, at the bottom of the housing 110. Air is to be supplied through the air intake to the consumable material 200 that is inserted into the housing 110. Hence, the flavor inhaler 100 is of a bottom-flow type. Providing an air intake at the position opposite the opening 10 simplifies the structure near the opening 10 of the housing 110. The shape of the housing 110 is not particularly limited, as long as the consumable material 200 is securable to the heater 120 with desired accuracy. For example, the shaping guide 20 and the retaining ribs 30 may be omitted.

The heater 120 is a flat plate-like PTC (positive-temperature-coefficient) heater to be inserted into the consumable material 200 that is accommodated into the housing 110, so that the consumable material 200 is to be heated from the inside. The heater 120 is designed to deform, in conformity with the shape of the heater 120, the outer shape of the consumable material 200 that is inserted into the housing 110.

The PTC heater is a heater including a resistor having a characteristic (PTC characteristic) in which the electrical resistance sharply increases at a certain temperature (called the Curie temperature) to reject the flow of electricity. The PTC heater is capable of keeping the temperature thereof at a certain level or below by utilizing the PTC characteristic, without using any control device or the like that is configured to stop the heating at the reaching of a predetermined temperature or above. The heater 120 may be a PTC heater employing a resistor including barium titanate (BaTiO3), which has the PTC characteristic. In such a case, the heater 120 is allowed to have a Curie temperature for barium titanate of 350° C. Therefore, the consumable material 200 is heatable at a preferable temperature of below 350° C.

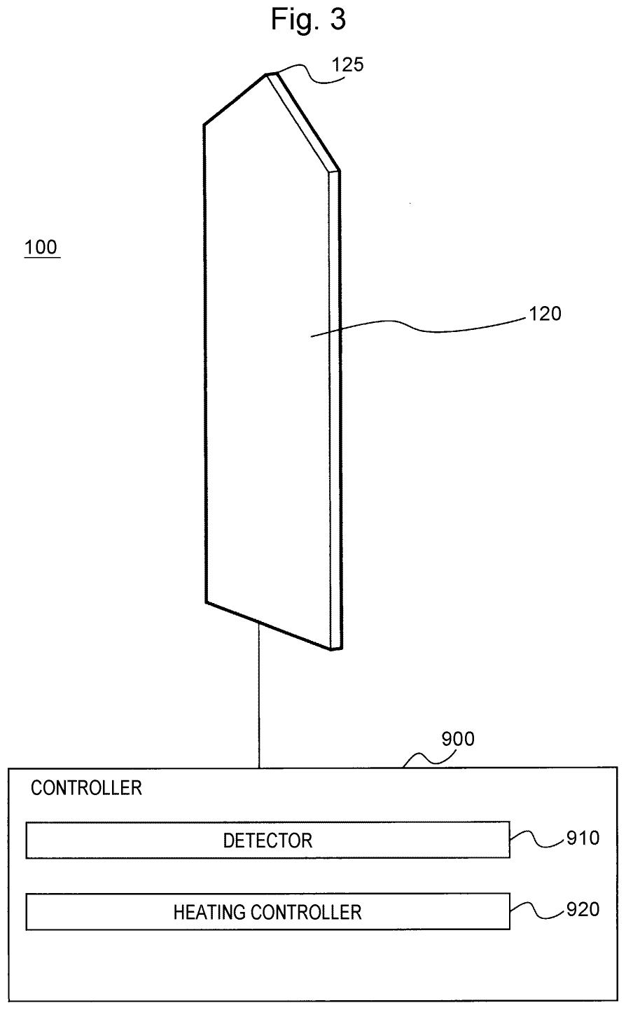

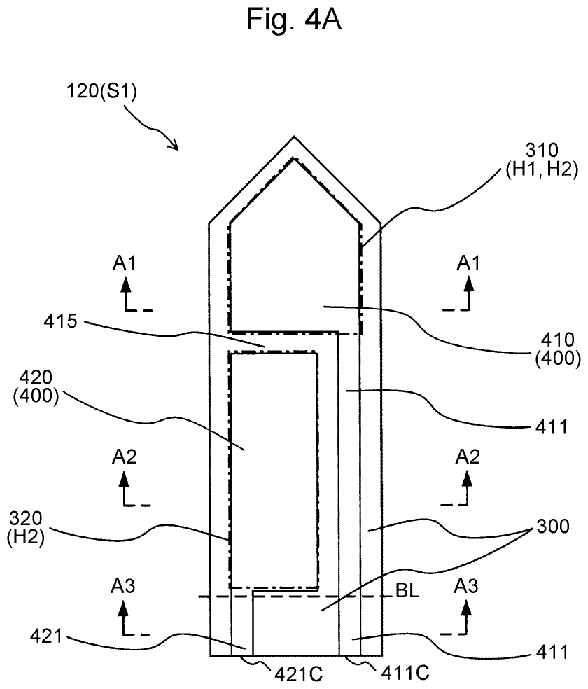

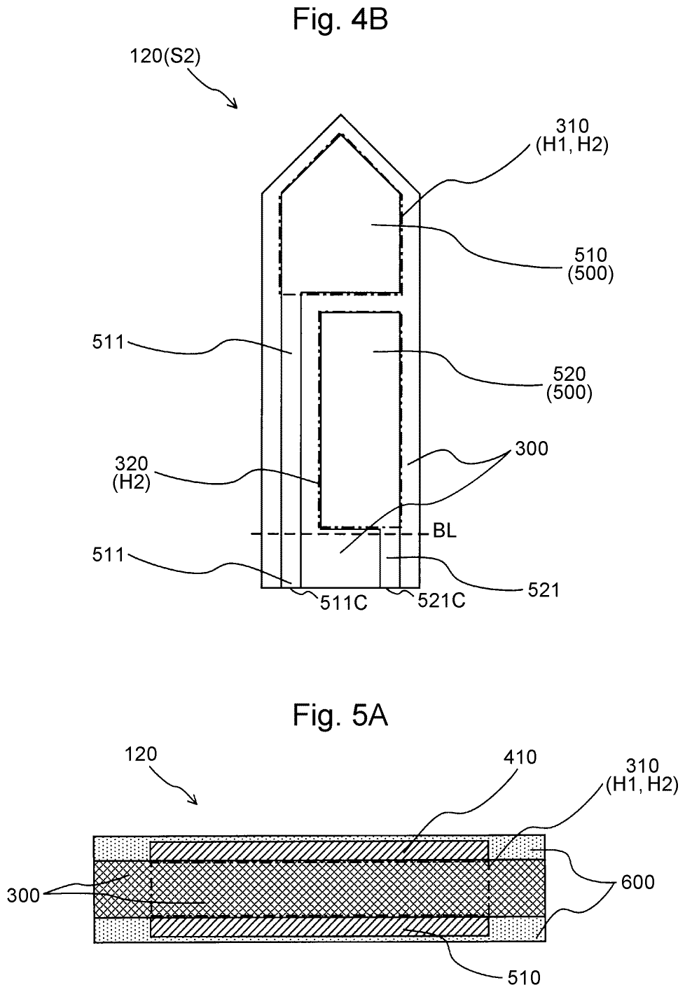

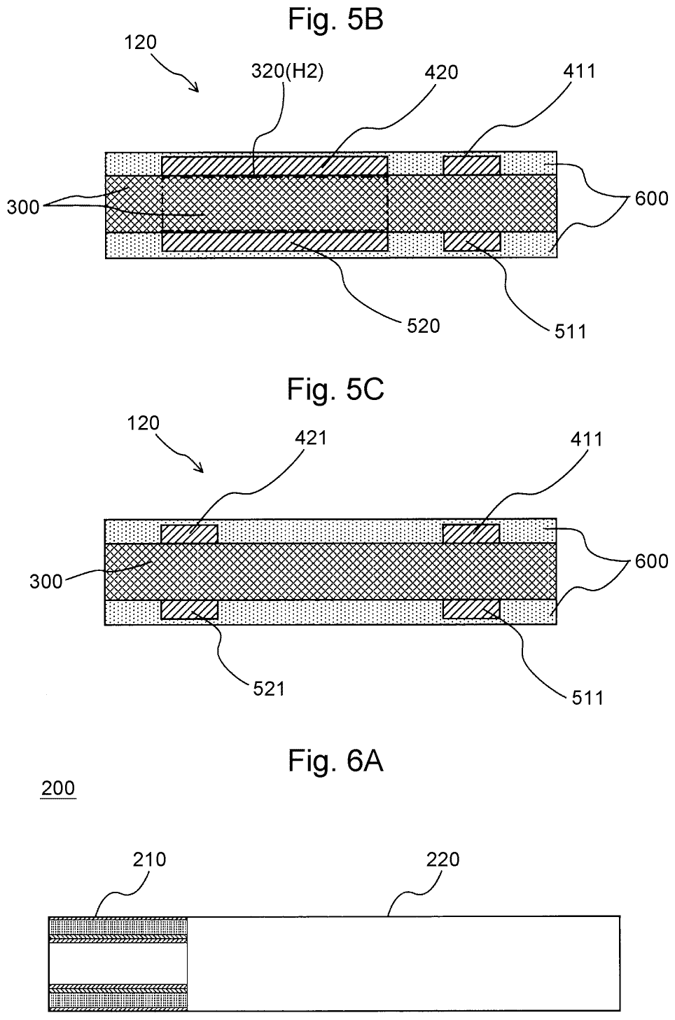

FIG. 3 is a conceptual diagram schematically illustrating the heater 120 and a controller 900, which is configured to control the heater 120. In FIG. 3, the heater 120 is illustrated in perspective view. FIG. 4A is a conceptual diagram schematically illustrating a configuration of the heater 120 on the side of a first surface S1. FIG. 4B is a conceptual diagram schematically illustrating a configuration of the heater 120 on the side of a second surface S2. Herein, one surface of the flat plate provided as the heater 120 is defined as the first surface S1, and another surface opposite the first surface is defined as the second surface S2. FIGS. 5A, 5B, and 5C are conceptual diagrams schematically illustrating an A1-A1 section, an A2-A2 section, and an A3-A3 section, respectively, taken from FIG. 4A.

As illustrated in FIG. 3, the heater 120 has a protrusion 125 on one side in the long-side direction thereof. The heater 120 is to be inserted into the consumable material 200 from the protrusion 125. Therefore, with the consumable material 200 being accommodated in the housing 110, the side of the heater 120 on which the protrusion 125 is provided is the side closer to the outside; that is, the downstream side of the path of an airflow generated by inhalation. In view of such a situation, hereinafter in the present embodiment, a side of the heater 120 in the long-side direction thereof on which the protrusion 125 is provided is referred to as the downstream side, and the side opposite thereto is referred to as the upstream side.

As illustrated in FIGS. 4A, 4B, 5A, 5B, and 5C, the heater 120 includes a heating element 300, a plurality of first energization regions 400, first connecting electrodes 411 and 421, a plurality of second energization regions 500, second connecting electrodes 511 and 521, and a coating 600. The heating element 300 includes a first heating section 310 and a second heating section 320. The plurality of first energization regions 400 include a first downstream region 410 and a first upstream region 420. The first downstream region 410 is located on the downstream side relative to the first upstream region 420. The plurality of second energization regions 500 include a second downstream region 510 and a second upstream region 520. The second downstream region 510 is located on the downstream side relative to the second upstream region 520.

The plurality of first energization regions 400 and the first connecting electrodes 411 and 421 are located on a side of the heating element 300 that corresponds to the first surface S1. The plurality of second energization regions 500 and the second connecting electrodes 511 and 521 are located on a side of the heating element 300 that corresponds to the second surface S2. Broken line BL given in FIGS. 4A and 4B represents the position where the leading end of a tobacco part 210, to be described separately below, is to be located when the consumable material 200 is accommodated in the housing 110. In the heating element 300, a portion on the downstream side relative to broken line BL is a region regarded as an object of heating and is referred to as an object region. The plurality of first energization regions 400 and the plurality of second energization regions 500 are located in the object region. At least a portion of each of the first connecting electrodes 411 and 421 and the second connecting electrodes 511 and 521 is located on the upstream side relative to the object region.

The heating element 300 is a PTC element having a PTC characteristic. The A1-A1 section illustrated in FIG. 5A and taken from FIG. 4A is a section containing the first heating section 310 of the heating element 300. The first heating section 310 is a region sandwiched between the first downstream region 410 and the second downstream region 510 in the direction of a normal to the first surface S1 (the direction is hereinafter simply referred to as the normal direction). The first heating section 310 is electrically connected to the first downstream region 410 and to the second downstream region 510. The first heating section 310 is to be heated with a current that is generated by a voltage to be applied between the first downstream region 410 and the second downstream region 510.

The A2-A2 section illustrated in FIG. 5B and taken from FIG. 4A is a section containing the second heating section 320 of the heating element 300. The second heating section 320 is a region sandwiched between the first upstream region 420 and the second upstream region 520 in the normal direction. The second heating section 320 is electrically connected to the first upstream region 420 and to the second upstream region 520. The second heating section 320 is to be heated with a current that is generated by a voltage to be applied between the first upstream region 420 and the second upstream region 520.

In the present embodiment, the first downstream region 410 and the second downstream region 510 each have a pentagonal flat plate shape in top view and are of substantially the same size. The first upstream region 420 and the second upstream region 520 each have an oblong rectangular flat plate shape in top view and are of substantially the same size. That is, in top view, the plurality of second energization regions 500 each overlap a corresponding one of the plurality of first energization regions 400. More specifically, as illustrated in FIGS. 4A and 4B, the plurality of second energization regions 500 may each preferably have the same size and shape as a corresponding one of the plurality of first energization regions 400 and coincide in top view with a corresponding one of the plurality of first energization regions 400. Thus, the second energization regions 500 each have a size and shape based on a corresponding one of the first energization regions 400 that overlaps therewith. Thus, the area to be heated is set accurately. Consequently, the heating of the heating element 300 is controllable with increased accuracy.

The heating element 300, the first energization regions 400, and the second energization regions 500 each have a flat plate shape. A direction perpendicular to the flat plate provided as the heating element 300 is defined as the thicknesswise direction of the heating element 300. In such a case, the heating element 300, the first energization regions 400, and the second energization regions 500 overlap one another in the thicknesswise direction of the heating element 300. Hence, the current flows through the heating element 300 in the thicknesswise direction of the heating element 300. Therefore, the consumable material is heated more evenly than with a heater, such as the one illustrated in FIG. 5 of PTL 2, in which heat is generated by metal wiring.

The first energization regions 400 and the second energization regions 500 are coated with the coating 600. Thus, the occurrence of short circuit with other conductive elements is suppressed. The material for the coating 600 that coats the first energization regions 400 and the second energization regions 500 is not particularly limited, as long as the material has an insulation characteristic and is formable over the first energization regions 400 and the second energization regions 500. The coating 600 formed over these regions may be, for example, a glass coating. Between the first downstream region 410 and the first upstream region 420 is provided a non-energization region 415, which is made of an insulating material. In the example illustrated in FIG. 4A, the non-energization region 415 is provided as the coating 600.

The first downstream region 410 is electrically connected to the controller 900 through the first connecting electrode 411. The first connecting electrode 411 extends in the long-side direction and on the upstream side relative to the first downstream region 410. The first connecting electrode 411 is electrically connected at a first end thereof to the first downstream region 410, and is connected at a second end thereof through a connecting part 411C to a conductive wire provided outside the heater 120. The connecting part 411C forms an upstream end face of the first connecting electrode 411. While the illustrated example relates to a case where the end face is a surface perpendicular to the long-side direction of the heater 120, the end face is not particularly limited thereto. This also applies to other connecting parts to be described below. The first upstream region 420 is electrically connected to the controller 900 through the first connecting electrode 421. The first connecting electrode 421 extends in the long-side direction and on the upstream side relative to the first upstream region 420. The first connecting electrode 421 is electrically connected at a first end thereof to the first upstream region 420, and is connected at a second end thereof through a connecting part 421C to a conductive wire provided outside the heater 120. The connecting part 421C forms an upstream end face of the first connecting electrode 421.

The second downstream region 510 is electrically connected to the controller 900 through the second connecting electrode 511. The second connecting electrode 511 extends in the long-side direction and on the upstream side relative to the second downstream region 510. The second connecting electrode 511 is electrically connected at a first end thereof to the second downstream region 510, and is connected at a second end thereof through a connecting part 511C to a conductive wire provided outside the heater 120. The connecting part 511C forms an upstream end face of the second connecting electrode 511. The second connecting electrode 521 extends in the long-side direction and on the upstream side relative to the second upstream region 520. The second upstream region 520 is electrically connected to the controller 900 through the second connecting electrode 521. The second connecting electrode 521 is electrically connected at a first end thereof to the second upstream region 520, and is connected at a second end thereof through a connecting part 521C to a conductive wire provided outside the heater 120. The connecting part 521C forms an upstream end face of the second connecting electrode 521.

The A3-A3 section illustrated in FIG. 5C and taken from FIG. 4A is a section containing the first connecting electrodes 411 and 421 and the second connecting electrodes 511 and 521. While the illustrated example relates to an arrangement where the first connecting electrode 421 is located opposite the second connecting electrode 521, and the first connecting electrode 411 is located opposite the second connecting electrode 511, the arrangement is not particularly limited thereto.

The surfaces of the first connecting electrodes 411 and 421 and the second connecting electrodes 511 and 521 excluding the connecting parts 411C, 421C, 511C, and 521C are insulated by the coating 600. The material for the coating 600 that coats the first connecting electrodes 411 and 421 and the second connecting electrodes 511 and 521 is not particularly limited, as long as the material has an insulation characteristic and is formable over the first connecting electrodes 411 and 421 and the second connecting electrodes 511 and 521. The coating 600 formed over these electrodes may be, for example, a glass coating. The connecting parts 411C and 421C may alternatively be provided at respective surfaces of the first connecting electrodes 411 and 421 that are on the side of the first surface S1. For example, lead wires may be connected to such surfaces near the end faces of the first connecting electrodes 411 and 421. The connecting parts 511C and 521C may alternatively be provided at respective surfaces of the second connecting electrodes 511 and 521 that are on the side of the second surface S2. For example, lead wires may be connected to such surfaces near the end faces of the second connecting electrodes 511 and 521.

As illustrated in FIGS. 4A and 4B, any electrodes excluding the first connecting electrodes 411 and 421 and the second connecting electrodes 511 and 521 extend along the first surface S1 and the second surface S2 at which the heating element 300 extends, without protruding from the area in which the heating element 300 extends. This is because any electrodes protruding from this area cause short circuit, which is to be reduced.

The materials for the first energization regions 400, the second energization regions 500, the first connecting electrodes 411 and 421, and the second connecting electrodes 511 and 521 are not particularly limited, as long as the materials are electrically conductive. The first energization regions 400, the second energization regions 500, the first connecting electrodes 411 and 421, and the second connecting electrodes 511 and 521 may preferably include metal or electrically conductive adhesive. If metal is used, the heater 120 is supported by utilizing the rigidity of the metal. The kind of such metal is not particularly limited. In view of factors such as rigidity or durability, stainless steel may be employed. If electrically conductive adhesive is used, relevant processing work is facilitated. The first energization regions 400, the second energization regions 500, the first connecting electrodes 411 and 421, or the second connecting electrodes 511 and 521 may be defined while a flat plate-like supporting member, which is not illustrated, and the heating element 300 are bonded to each other with electrically conductive adhesive. Such electrically conductive adhesive may be, for example, so-called anisotropic conductive adhesive obtained by evenly dispersing electrically conductive particles into epoxy-based adhesive.

Referring back to FIG. 3, the flavor inhaler 100 includes the controller 900. The controller 900 includes a detector 910 and a heating controller 920. The controller 900 includes a processing device such as a PCB (printed circuit board). The processing device includes a CPU, a memory, and so forth and is configured to control the operation of the flavor inhaler 100.

The detector 910 is configured to detect the start of inhalation. The detector 910 is configured to detect an operation performed by the user on an input device, not illustrated, such as a push button or a slide switch. Alternatively, the detector 910 is configured to detect a puff action performed by the user. After such detection, the detector 910 performs a processing operation to cause the heating controller 920 to start voltage application for heating.

The heating controller 920 is configured to control the heating of the first heating section 310 and the second heating section 320 individually by electrically controlling the plurality of first energization regions 400 individually. The heating controller 920 is capable of controlling the respective voltages or currents of the first downstream region 410 and the first upstream region 420, included in the first energization regions 400, independently of each other. That is, the heating controller 920 is capable of controlling the heating of the first heating section 310 and the heating of the second heating section 320 independently of each other.

In the example of the present embodiment, the heating controller 920 is configured to electrically control the plurality of first energization regions 400 such that a first heating region H1 is first heated and then a second heating region H2 is heated. The first heating region H1 includes the first heating section 310. The second heating region H2 includes the first heating section 310 and the second heating section 320.

When the detector 910 performs a processing operation of indicating that the start of inhalation has been detected, the heating controller 920 heats the first heating region H1. The first heating region H1 has a smaller surface area than the second heating region H2. Therefore, heating the first heating region H1 alone more locally heats the tobacco part 210 and accelerates the release of a flavor component. Thus, the time from when the user starts operating the flavor inhaler 100 until the user is able to inhale the flavor is shortened. In view of such circumstances, if the surface area of the first heating section 310 is smaller than the surface area of the second heating section 320, the second heating region H2 may include the second heating section 320 but no first heating section 310.

In the example of the present embodiment, the first heating region H1 is located on the downstream side relative to the second heating region H2. Therefore, aerosol containing the flavor component released with the heating of the first heating region H1 is not hindered by the tobacco part 210 (to be described below) halfway down the flow path during inhalation. Hence, the flavor component is efficiently delivered to the user. Herein, the situation where “the first heating region H1 is located on the downstream side relative to the second heating region H2” includes a situation where the first heating region H1 is included in the second heating region H2 and is located in a downstream portion of the second heating region H2. Note that the first heating region H1 does not necessarily need to be located on the downstream side relative to the second heating region H2. Even in such a case, at least the advantageous effect of accelerating the release of the flavor component is produced.

The heating controller 920 starts heating the second heating region H2 if a switching condition is satisfied. The switching condition is as follows: the reaching of a predetermined period of time after the heating of the first heating region H1 is started; the reception of an input made by the user through the input device, not illustrated; or the like. For example, the flavor inhaler 100 may be provided with a button for heating the entirety of the below-described tobacco part 210, allowing the user to press the button to cause the heating controller 920 to start the heating of the second heating region H2. Whether to stop the heating of the first heating region H1 before the heating of the second heating region H2 is started is not particularly limited.

The heating controller 910 ends the heating if an end condition is satisfied. The end condition is as follows: the reaching of a predetermined period of time after the heating is started; the exceeding of a certain value by the number of times of the user's puff actions; or the like.

Hereinafter, each of the first heating region H1 and the second heating region H2 is referred to as the heating region when they are not distinguished from each other. Furthermore, each of the first heating section 310 and the second heating section is referred to as the heating section when they are not distinguished from each other. The number, the sizes, the shapes, and the locations of the heating sections are not particularly limited and may be set in correspondence with the manner of heating control. The number of the heating regions is also not particularly limited and may be a combination of any one or more heating sections.

FIG. 6A is a schematic side sectional view of the consumable material 200 according to the embodiment. FIG. 6B is a sectional view of the tobacco part 210 that is taken orthogonally to the long-side direction of the consumable material 200 illustrated in FIG. 6A. As illustrated in FIGS. 6A and 6B, the consumable material 200 includes the tobacco part (insertion part) 210 and a paper tube 220. The tobacco part 210 has in the center thereof a through-hole 211, into which the heater 120 is to be inserted. Furthermore, the tobacco part 210 includes a flavor-releasing layer (annular sheet) 212 and an elastically deformable layer (annular sheet) 213, which are provided in such a manner as to surround the heater 120 to be inserted. The flavor-releasing layer 212 has a two-layer structure. Around the outer periphery of the elastically deformable layer 213 is wrapped a wrapper 214.

The flavor-releasing layer 212 includes, for example, a tobacco sheet and a non-tobacco sheet. The non-tobacco sheet is provided over the outer periphery of the tobacco sheet and carries glycerine. When heated by the heater 120, the flavor-releasing layer 212 releases a volatile compound containing a flavor. Note that the flavor-releasing layer 212 may include only one of the tobacco sheet and the non-tobacco sheet. The elastically deformable layer 213 includes, for example, any of a nonwoven fabric sheet, a corrugated sheet, a non-tobacco sheet, and the like. The elastically deformable layer 213 is elastically deformable in the thicknesswise direction thereof (i.e., the radial direction of the cylindrical elastically deformable layer 213). When the heater 120 is inserted, the elastically deformable layer 213 helps the consumable material 200 deform in conformity with the shape of the heater 120.

Therefore, when the heater 120 is inserted into the through-hole 211, the elastically deformable layer 213 elastically deforms in the thicknesswise direction relative to the heater 120, which facilitates the contact with or close positioning relative to the heater 120. Thus, the flavor-releasing layer 212 is brought into closer contact with or is brought in proximity to the heater 120, allowing the consumable material 200 to be heated efficiently.

The paper tube 220 is to cool the volatile compound that is released from the flavor-releasing layer 212. Since the tobacco part 210 includes the flavor-releasing layer 212 and the elastically deformable layer 213 provided in such a manner as to surround the heater 120 to be inserted, the consumable material 200 is easily deformable with the insertion of the heater 120 into the consumable material 200. Note that the cross-sectional shape of the consumable material 200 may be circular or oval.

Herein, the non-tobacco sheet may include a flavor-generating base. The flavor-generating base may preferably be a material that imparts a flavorsome smoke taste and be a tobacco material. The flavor-generating base may further contain a flavoring agent. The flavoring agent is a substance that imparts some flavor or taste. The flavoring agent may be a natural flavoring agent or a synthetic flavoring agent. The flavoring agent may be of a single kind or a mixture of a plurality of kinds of flavoring agents. The flavoring agent may be of any kind that is normally used, such as essential oil, a natural flavoring agent, a synthetic flavoring agent, or the like. Moreover, the attribute of the flavoring agent is not limited and may be liquid or solid. Furthermore, the flavor-generating base may contain a refrigerant or a spicy agent.

On the other hand, the tobacco sheet may contain, for example, tobacco, polyhydric alcohol, or the like. Polyhydric alcohol for the tobacco sheet may be used alone or may be a combination of two or more kinds. Polyhydric alcohol may be added to the above-described elastically deformable layer 213. The tobacco sheet in a sheet form may be obtained by mixing tobacco powder and polyhydric alcohol with a binder.

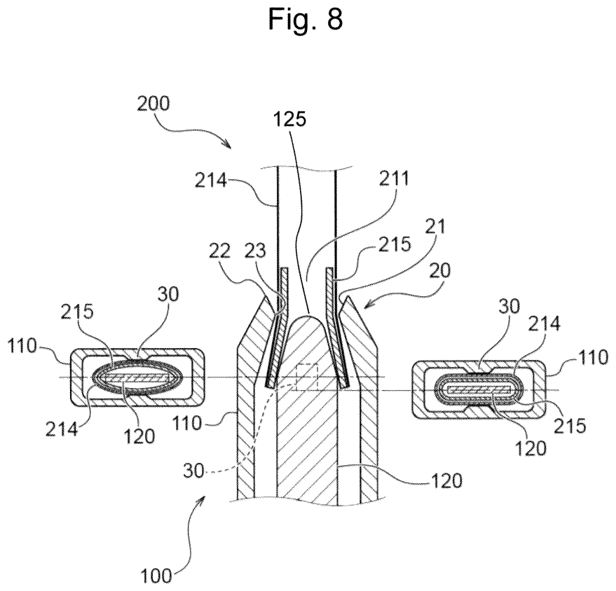

Now, the relationship between the consumable material 200 and the heater 120 of the housing 110 will be described that is to be established when the consumable material 200 is accommodated into the flavor inhaler 100; that is, when the consumable material 200 is inserted into the housing 110 from the one-end side toward the other-end side of the housing 110. FIGS. 7 to 9 illustrate in sectional view how the consumable material 200 is accommodated into the flavor inhaler 100. Herein, applying the consumable material 200 to the flavor inhaler 100 provides a flavor inhalation system. In FIGS. 7 to 9, the flavor-releasing layer 212 and the elastically deformable layer 213 of the consumable material 200 are collectively illustrated as a single annular sheet 215.

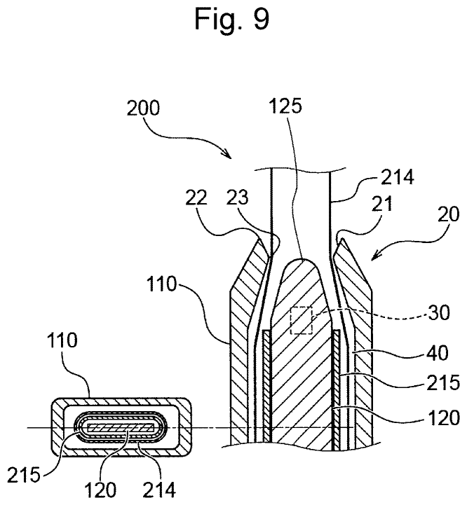

FIG. 7 illustrates a state where the consumable material 200 is passing through the shaping guide 20, in a section taken in the widthwise direction of the heater 120 and in a section taken orthogonally to the long-side direction of the housing 110 at an inlet part 22 of the shaping guide 20. FIG. 8 illustrates a state where the consumable material 200 is passing through between the retaining ribs 30, in the section taken in the widthwise direction of the heater 120 and in sections taken orthogonally to the long-side direction of the housing 110 at a middle point of the retaining ribs 30 and at an end point of the retaining ribs 30 that is on the other-end side. FIG. 9 illustrates a state where the consumable material 200 has been accommodated at a predetermined accommodation position in the housing 110, in the section taken in the widthwise direction of the heater 120 and in a section taken orthogonally to the long-side direction of the housing 110 near an end of the heater 120 on the other-end side.

As illustrated in FIG. 7, the shaping guide 20 includes a tapered part 21, the inlet part 22, and a contact part 23. The tapered part 21 has a diameter increasing toward the one-end side of the housing 110 so as to guide the insertion of the consumable material 200 into the flavor inhaler 100. The inlet part 22 is at an end of the housing 110 and has an oval cross section, with the major diameter being greater than or equal to the major diameter of the consumable material 200 after being accommodated into the housing 110, and the minor diameter being substantially the same as the diameter of the consumable material 200 before being accommodated into the housing 110. The contact part 23 is at the inner peripheral surface of the housing 110 and has an oval cross section, with the smallest inner perimeter being substantially the same as the outer perimeter of the consumable material 200. Therefore, when the consumable material 200 passes through the shaping guide 20, the entire periphery of the consumable material 200 comes into contact with the contact part 23. Hence, the sectional shape of the consumable material 200 is deformed in conformity with the shape of the inlet part 22.

As illustrated in FIG. 8, the heater 120 includes the protrusion 125, which is pointed on the one-end side. Thus, the insertion of the heater 120 into the consumable material 200 is facilitated. The heater 120 has a width that increases toward the other-end side. Therefore, as the consumable material 200 passes through the shaping guide 20 and is further inserted, the outer shape of the consumable material 200 is deformed in conformity with the shape of the heater 120. Specifically, the consumable material 200 is pushed to be widened in the widthwise direction of the heater 120. Thus, the consumable material 200 is brought into close contact with the heater 120, which increases the efficiency of heat transfer from the heater 120 to the consumable material 200. Furthermore, since the heater 120 pushes and widens the consumable material 200, the consumable material 200 is prevented from coming off.

Specifically, the heater 120 has a flat plate shape. Therefore, the consumable material 200 inserted into the housing 110 is deformed to have an outer shape with an oval cross section. In this state, the major diameter of the consumable material 200 after being accommodated into the housing 110 is greater than the diameter of the consumable material 200 before being accommodated into the housing 110, and the minor diameter of the consumable material 200 after being accommodated into the housing 110 is shorter than the diameter of the consumable material 200 before being accommodated into the housing 110. Since the consumable material 200 inserted into the housing 110 is deformed by the heater 120 to have an outer shape with an oval cross section, the length of the area occupied by the consumable material 200 is shortened in the short-side direction of the housing 110. Therefore, the housing 110 is providable with a reduced thickness. Furthermore, since the consumable material 200 inserted into the housing 110 is deformed by the heater 120 to have an outer shape with an oval cross section, the area of contact between the heater 120 and the consumable material 200 is increased. Therefore, the efficiency of heat transfer from the heater 120 to the consumable material 200 is increased.

As illustrated in FIG. 9, in the state where the consumable material 200 has been accommodated at the predetermined accommodation position in the housing 110, an air layer 40 is provided between the consumable material 200 and the housing 110 over the entire periphery of the consumable material 200. The air layer 40 has a low thermal conductivity and is therefore capable of insulating heat between the consumable material 200 and the housing 110. Thus, the energy required for heating the consumable material 200 is reduced. Furthermore, the inlet part 22 is in contact with the consumable material 200 over the entire outer periphery of the consumable material 200, thereby sealing the air layer 40. Thus, the convection of air in the air layer 40 is reduced.

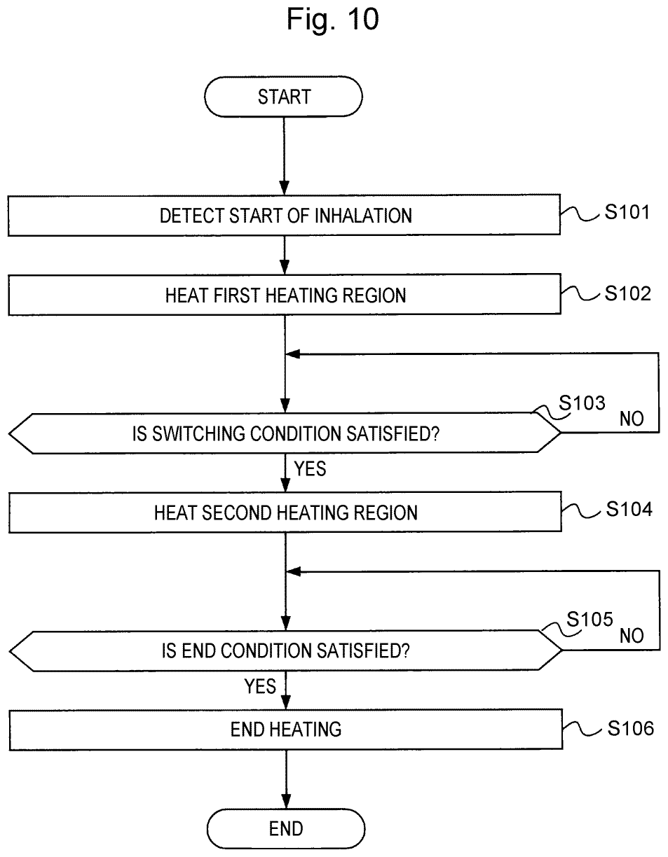

FIG. 10 is a flow chart illustrating a process of releasing the flavor according to the embodiment. The present releasing process is initiated by the controller 900. In the present releasing process, the plurality of heating sections 310 and 320 are subjected to heating control independently of each other. Such a method enables flexible control of the release of the flavor component. Furthermore, at the start of inhalation, a portion of the heating element 300 is heated. Thus, the time taken until the flavor is generated is shortened.

In step S101, the detector 910 detects the start of the user's inhalation. After step S101, step S102 is executed. In step S102, the heating controller 920 applies a voltage between the first downstream region 410 and the second downstream region 510, thereby heating the first heating region H1 of the heating element 300. After step S102, step S103 is executed.

In step S103, the heating controller 920 checks whether the switching condition is satisfied. If the switching condition is satisfied, a YES determination is made in step S103. Accordingly, step S104 is executed. If the switching condition is not satisfied, a NO determination is made in step S103. Accordingly, step S103 is repeated.

In step S104, the heating controller 920 applies a voltage between the first downstream region 410 and the second downstream region 510 and between the first upstream region 420 and the second upstream region 520, thereby heating the second heating region H2 of the heating element 300. After step S104, step S105 is executed.

In step S105, the heating controller 920 checks whether the end condition is satisfied. If the end condition is satisfied, a YES determination is made in step S105. Accordingly, step S106 is executed. If the end condition is not satisfied, a NO determination is made in step S105. Accordingly, step S105 is repeated.

In step S106, the heating controller 920 ends the heating. When step S106 ends, the process ends.

The flavor inhaler 100 and the flavor inhalation system according to the present embodiment each include the heater 120. The heater 120 includes the heating element 300 and the plurality of first energization regions 400. The heating element 300 includes the first heating section 310 and the second heating section 320, which correspond to a plurality of heating portions. The plurality of first energization regions 400 are electrically connected to the respective heating portions. Thus, individual ones of the plurality of heating portions are controllable flexibly through the first energization regions 400. Therefore, the flavor component is releasable in correspondence with the user's preference, convenience, or the like.

Modifications given below are also within the scope of the present invention and may each be combined with the above embodiment or may each be combined with any other modifications. In the following modifications, any portions or the like having like structures or functions as in the above embodiment are denoted by like reference signs, and redundant description thereof is omitted.

### MODIFICATION 1

In the above embodiment, the size and shape of each of the second energization regions provided across the heating element from the first energization regions does not necessarily need to be based on the size and shape of the corresponding first energization region.

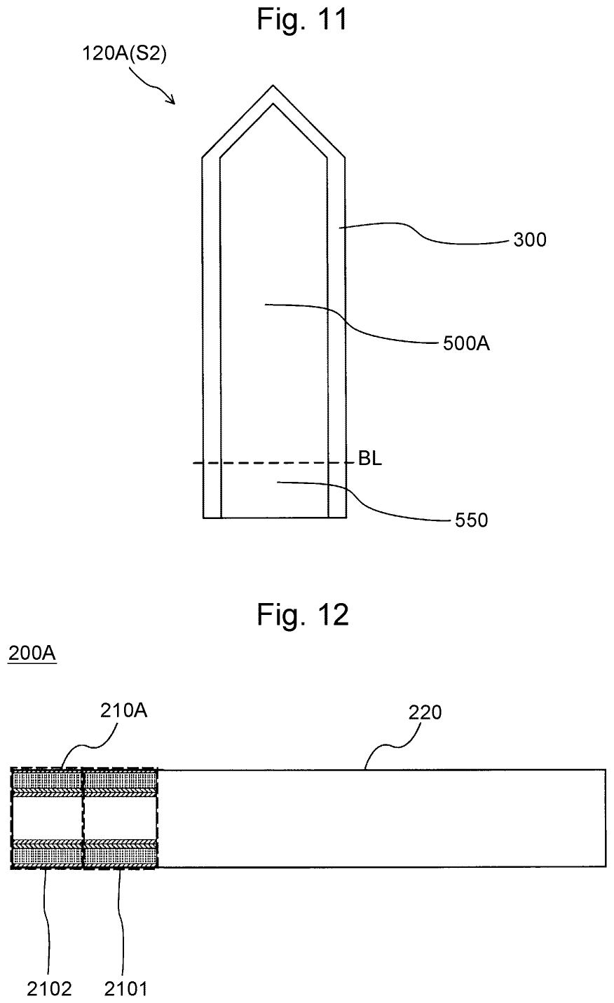

FIG. 11 is a conceptual diagram schematically illustrating a configuration of a heater 120A according to the present modification on the side of the second surface S2. The configuration on the side of the first surface S1 is the same as in the above embodiment. The heater 120A includes a second energization region 500A and a second connecting electrode 550, which are formed on the heating element 300. The second energization region 500A is obtained as an integration of the second downstream region 510 and the second upstream region 520 included in the second energization region 500 according to the above embodiment. The second connecting electrode 550 is obtained as an integration of the second connecting electrodes 511 and 512 according to the above embodiment. In the illustrated example, the second energization region 500A and the second connecting electrode 550 are integrated together. Specifically, with reference to broken line BL, the downstream portion (the region to be heated) of the integrated electrode serves as the second energization region 500A, and the upstream portion (the region not to be heated) of the integrated electrode serves as the second connecting electrode 550. Furthermore, the second energization region 500A faces, with the heating element 300 in between, not only the plurality of first energization regions 400 but also the non-energization region 415 (FIG. 4A) provided between the plurality of first energization regions 400.

The second energization region 500A and the second connecting electrode 550 may each preferably include electrically conductive adhesive or a metal electrode. If metal electrode is used, the heater 120A is supported by utilizing the rigidity of the metal. The kind of such metal is not particularly limited. In view of factors such as rigidity and durability, stainless steel may be employed. If electrically conductive adhesive is used, relevant processing work is facilitated. The second energization region 500A or the second connecting electrode 550 may be defined while a flat plate-like supporting member, which is not illustrated, and the heating element 300 are bonded to each other with electrically conductive adhesive. Such electrically conductive adhesive may be, for example, the above-described anisotropic conductive adhesive. The flat plate-like supporting member may be made of, for example, stainless steel in view of factors such as rigidity and durability.

In the flavor inhaler according to the present modification, the heater 120A includes the second energization region 500A that faces both the region between the plurality of first energization regions 400 and the plurality of first energization regions 400. Therefore, the processing work of obtaining the second energization region 500A is facilitated. If the second energization region 500A is formed of a metal electrode or is bonded to a metal electrode with electrically conductive adhesive, the heating element 300 is supported by utilizing the metal electrode.

### MODIFICATION 2

In the above embodiment, the consumable material may include a plurality of flavor-generating sections having respective flavor components.

FIG. 12 is a schematic side sectional view of a consumable material 200A according to the present modification. The consumable material 200A includes a tobacco part 210A and a paper tube 220. The tobacco part 210A includes a first flavor-generating section 2101 and a second flavor-generating section 2102. With the consumable material 200A being accommodated in the housing 110, the first flavor-generating section 2101 and the second flavor-generating section 2102 are positioned facing the first heating section 310 and the second heating section 320, respectively. The first flavor-generating section 2101 is to be heated by the first heating section 310. The second flavor-generating section 2102 is to be heated by the second heating section 320. The flavor components provided in the first flavor-generating section 2101 and the second flavor-generating section 2102 are not particularly limited. The tobacco part 210A may include three or more flavor-generating sections.

In the flavor inhalation system according to the present modification, the consumable material 200A includes the plurality of flavor-generating sections 2101 and 2102 having respective flavor components. At the time of the user's inhalation, the plurality of flavor-generating sections 2101 and 2102 are positioned respectively facing the first heating section 310 and the second heating section 320, which correspond to a plurality of heating portions. Thus, the release of the flavor components from the flavor inhalation system is controllable more flexibly. Furthermore, the allocation of the flavor components among the above plurality of portions may be determined in correspondence with the user's preference, convenience, or the like.

### MODIFICATION 3

In the above embodiment, a plurality of heating elements may be laminated with electrodes in between.

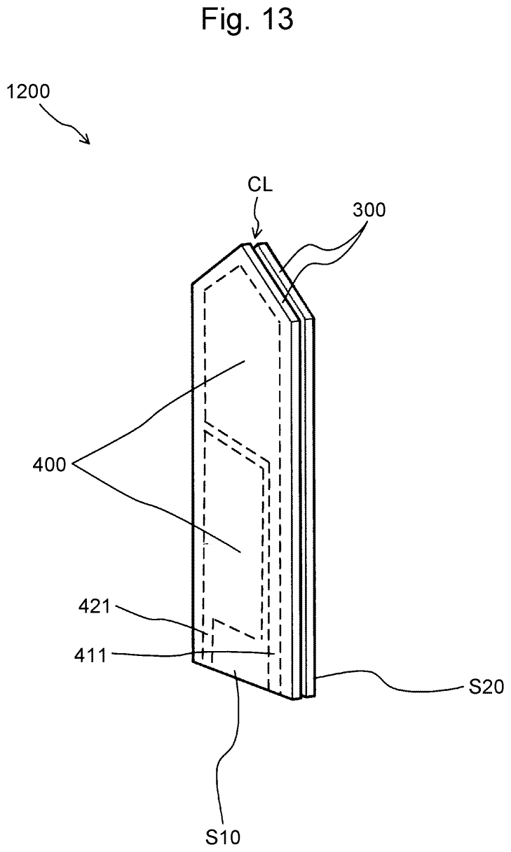

FIG. 13 is a perspective view of a heater 1200 according to the present modification. The heater 1200 has a structure in which the first energization regions 400 and the first connecting electrodes 411 and 421 are provided between two heating elements 300. In FIG. 13, the arrangement of the first energization regions 400 and the first connecting electrodes 411 and 421 in a gap CL between the two heating elements 300 is schematically illustrated by broken lines.

The heater 1200 has a flat plate shape. The flat plate provided as the heater 1200 has a first surface S10 and a second surface S20, which is opposite the first surface S10. Second energization regions 500 and second connecting electrodes 511 and 512, which are not illustrated, are provided at each of the first surface S10 and the second surface S20. That is, in the heater 1200, the second energization regions 500, the heating element 300, the first energization regions 400, the heating element 300, and the second energization regions 500 are laminated in that order and are electrically connected to one another. In view of supporting the heater 1200, it is preferable to provide a flat plate-like supporting member at each of the first surface S10 and the second surface S20, or to employ metal electrodes as the first energization regions 400, the second energization regions 500, or the like.

Since the flavor inhaler according to the present modification includes the first energization regions 400 as electrodes shared by and electrically connected to the two heating elements 300, the heater 1200 is efficiently manufacturable. Furthermore, the two heating elements 300 are controllable independently of each other for heating. Therefore, more flexible heating of the tobacco part 210 is possible.

Alternatively, the second energization regions 500 may be provided between two heating elements 300, with the first energization regions 400 being provided at each of the first surface S10 and the second surface S20. Moreover, the number of heating elements 300 to be included in the heater 1200 is not particularly limited. Three or more heating elements 300 may be laminated with the first energization regions 400 or the second energization regions 500 sandwiched between the heating elements 300.

### MODIFICATION 4

In the above embodiment, the numbers, shapes, and locations of the first energization regions 400 and the second energization regions 500 are not particularly limited and may be determined as appropriate on the basis of, for example, how to heat the tobacco part 210. Furthermore, as long as the first energization regions 400 and the second energization regions 500 are electrically controllable, the manner of connection from the controller 900 is not particularly limited.

While an embodiment of the present invention has been described above, the above embodiment of the present invention is provided for ease of understanding of the present invention and does not limit the present invention. The present invention can be changed or improved without departing from the essence thereof, and the present invention encompasses such equivalents. The elements described in the appended claims and this specification may be combined or omitted to the extent that at least part of the above technical problem is solved or to the extent that at least part of the above advantageous effects is produced.

### REFERENCE SIGNS LIST

10 opening
20 shaping guide
30 retaining rib
100 flavor inhaler
110 housing
120, 120A, 1200 heater
200, 200A consumable material
210, 210A tobacco part
220 paper tube
300 heating element
310 first heating section
320 second heating section
400 first energization region
410 first downstream region
415 non-energization region
411, 421 first connecting electrode
411C, 421C, 511C, 521C connecting part
420 first upstream region
500, 500A second energization region
510 second downstream region
511, 521, 550 second connecting electrode
520 second upstream region
600 coating
900 controller
910 detector
920 heating controller
2101 first flavor-generating section
2102 second flavor-generating section
H1 first heating region
H2 second heating region

1. A flavor inhaler comprising a heater,
wherein the heater comprises:
a heating element which includes a plurality of heating portions; and
a plurality of first energization regions electrically connected to the respective heating portions.

2. The flavor inhaler according to claim 1, further comprising a heating controller configured to control heating by electrically controlling individual ones of the plurality of first energization regions.

3. The flavor inhaler according to claim 2,
wherein the heating controller is configured to control the plurality of first energization regions in such a manner as to heat in order of a first heating region and a second heating region, the first heating region and the second heating region each including one or more of the plurality of heating portions, and
wherein a surface area of the second heating region is greater than a surface area of the first heating region.

4. The flavor inhaler according to claim 3, wherein the first heating region is located, along a path of an airflow generated by flavor inhalation, on a downstream side relative to the second heating region.

5. The flavor inhaler according to claim 1,
wherein the heater further comprises one or a plurality of second energization regions, and
wherein the plurality of first energization regions or the one or the plurality of second energization regions each include electrically conductive adhesive or a metal electrode.

6. The flavor inhaler according to claim 5, wherein the metal electrode includes stainless steel.

7. The flavor inhaler according to claim 5, wherein the heater comprises the second energization region that faces both a region between the plurality of first energization regions and the plurality of first energization regions.

8. The flavor inhaler according to claim 5, wherein the plurality of second energization regions each have a shape based on a corresponding one of the first energization regions that overlap respective ones of the plurality of second energization regions.

9. The flavor inhaler according to claim 5, wherein the heater comprises a connecting electrode electrically connected to the first energization region or to the one or the plurality of second energization regions and extending in a long-side direction of the heating element.

10. The flavor inhaler according to claim 9, wherein the connecting electrode includes a connecting part provided for external connection and being located at or near an end face of the connecting electrode, with a surface of the connecting electrode excluding the connecting part being insulated.

11. The flavor inhaler according to claim 9, wherein any electrodes excluding the connecting electrode extend along a surface at which the heating element extends, without protruding from an area in which the heating element extends.

12. The flavor inhaler according to claim 5, wherein the plurality of first energization regions or the one or the plurality of second energization regions are covered with glass.

13. The flavor inhaler according to claim 1, further comprising:
an accommodation part configured to accommodate a consumable material having a flavor component,
wherein the consumable material is to be positioned in the accommodation part such that the heater is inserted into the consumable material.

14. The flavor inhaler according to claim 1, wherein the heating element includes a PTC element.

15. The flavor inhaler according to claim 1, wherein the heating element has a flat plate shape.

16. The flavor inhaler according to claim 15,
wherein the first energization regions each have a flat plate shape,
wherein the heating element and the first energization regions overlap each other in a thicknesswise direction of the heating element, and
wherein the heating element allows a current to flow through in the thicknesswise direction.

17. The flavor inhaler according to claim 1, wherein the heating element of the heater is a lamination of two or more heating elements.

18. A flavor inhalation system comprising:
a consumable material having a flavor component; and
the flavor inhaler according to claim 1.

19. The flavor inhalation system according to claim 18, wherein the consumable material includes a plurality of portions each being positioned facing a corresponding one of the plurality of heating portions at a time of inhalation, the plurality of portions having respective flavor components.
